(19) United States
(12) Patent Application Publication
(10) Pub. No.: US 2024/0280492 A1
(43) Pub. Date: Aug. 22, 2024

(54) METHOD AND SYSTEM FOR PFAS DETECTION IN WATER SOURCES

(71) Applicant: TOM Y. HUANG, WELLESLEY, MA (US)

(72) Inventor: TOM Y. HUANG, WELLESLEY, MA (US)

(21) Appl. No.: 18/110,926

(22) Filed: Feb. 17, 2023

(51) Int. Cl. G01N 21/65; B82Y 15/00

(52) U.S. Cl. CPC G01N 21/658; B82Y 15/00; G01N 2021/945

(57) ABSTRACT

A method for detecting Per- and polyfluoroalkyl substances (PFAS) in water sources includes taking a water sample from the water source and mixing metallic nanoparticles into the water sample, depositing a thin film of the mixed water with the metallic nanoparticles on a substrate and then performing Raman spectroscopy on the prepared thin film of the mixed water with the metallic nanoparticles to obtain a Raman spectrum and detect presence of a difluoromethylene (CF₂) vibrational peak of the PFAS in the Raman spectrum.

### FIELD OF THE INVENTION

The present invention relates to a method and a system for detecting Per- and polyfluoroalkyl substances (PFAS) in water sources, and in particular to a method of detecting PFAS in water sources using Surface-Enhanced Raman Spectroscopy (SERS).

### BACKGROUND OF THE INVENTION

Per- and polyfluoroalkyl substances (PFAS) are a group of commonly manufactured fluorocarbons. Due to their chemical inertness, they have been widely applied since the 1950s in consumer products such as food packaging and stain-resistant carpeting. The carbon-fluorine bonds that form the structure of PFAS are extremely strong; fluorine forms the strongest single bond with carbon. Therefore, PFASs do not break down easily in the environment, persisting long enough to harm public health. Release of polyfluoroalkyl chemicals into the environment can result in the formation of perfluoroalkyl carboxylic (PFCAs) and sulfonic acids (PFSAs), such as perfluorooctanoic acid (PFOA) and perfluorooctane sulfonic acid (PFOS). Because of their high water solubility, they are ubiquitous in drinking water sources, including groundwater, which becomes the main source of exposure to humans.

Generally, water is considered a major source of PFAS exposure. PFAS can enter our bodies not only through drinking water but also through the aquatic ecosystem, where environmental PFAS have entered human food sources. 97% of Americans have detectable PFAS levels in their blood. PFAS has been linked to multiple diseases, including kidney and testicular cancer, thyroid disease, and hyperlipidemia. Currently, no PFAS toxicity level exists.

Conventional methods for PFAS detection commonly utilize liquid chromatography-mass spectrometry (LC-MS) and gas chromatography-mass spectrometry (GC-MS) approaches. Both methods work on similar principles and are capable of achieving detection limits at the ng/L level.

However, these approaches are not sensitive enough. Research based on toxicology reports has suggested regulatory PFAS limits of less than one ng/L, which is below the detection limits of current methods. Additionally, these methods are time-consuming and hard to access. A significant limitation is that they can only analyze a small fraction of the thousands of existing PFAS chemicals. The sheer number of PFAS variants presents a challenge for current methods to report accurate concentrations. These limitations inhibit scientific understanding and exploration in an already limited field. Thus, a more sensitive and easy to use sensing method that can estimate the concentration of all PFASs in water sources is needed.

### SUMMARY OF THE INVENTION

The present invention describes a method and a system for detecting Per- and polyfluoroalkyl substances (PFAS) in water sources using silver nanoparticles for Surface-Enhanced Raman Spectroscopy (SERS).

In general, in one aspect the invention provides a method for detecting Per- and polyfluoroalkyl substances (PFAS) in water sources including the following steps. First, taking a water sample from the water source and mixing metallic nanoparticles into the water sample. Next, depositing a thin film of the mixed water with the metallic nanoparticles on a substrate. Next, performing Raman spectroscopy on the prepared thin film of the mixed water with the metallic nanoparticles to obtain a Raman spectrum and detect presence of a difluoromethylene (CF₂) vibrational peak of the PFAS in the Raman spectrum.

Implementations of this aspect of the invention include one or more of the following. The method of further includes comparing the CF₂ vibrational peak intensity of the PFAS to a calibration curve to obtain the PFAS concentration in the water sample. The CF₂ vibrational peak of the PFAS is detected at a wavelength of 1300 cm⁻¹ under excitation by a 785 nm laser light. The metallic nanoparticles comprise 40 nm silver nanoparticles (AgNPs). The metallic nanoparticles comprise a dispersion of AgNPs having a concentration of 0.02 mg/mL in aqueous buffer with sodium citrate as stabilizer. The thin film is prepared by drop-casting onto the substrate. The thin film is prepared by spin-coating onto the substrate. The metallic nanoparticles are mixed into the water sample in a ratio of 2:3 water to metallic nanoparticles by volume. The metallic nanoparticles are mixed into the water sample using a mixer for 15 sec. The PFAS comprises a perfluorooctane sulfonic acid (PFOS) and the calibration curve for the PFOS is a logarithmic least squares fit equation of:

$$Y = 0.0044 ln ( x ) + 0.0561 .$$

The PFAS comprises a perfluorooctanoic acid (PFOA) and the calibration curve for the PFOA is a logarithmic least squares fit equation of:

$$Y = 0.0042 ln ( x ) + 0.0631 .$$

The substrate comprises aluminum. The CF₂ vibrational peak intensity of the PFAS is divided by the metallic nanoparticle particle peak intensity to correct for a heterogeneous distribution of the metallic nanoparticles in the thin film. The Raman spectrum acquisition time is scaled to 120 seconds exposure time.

In general, in another aspect the invention provides a system for detecting Per- and polyfluoroalkyl substances (PFAS) in water sources including equipment for mixing metallic nanoparticles into a water sample taken from the water source, equipment for depositing a thin film of the mixed water with the metallic nanoparticles on a substrate, and equipment for performing Raman spectroscopy on the prepared thin film of the mixed water with the metallic nanoparticles to obtain a Raman spectrum and detect presence of a difluoromethylene (CF₂) vibrational peak of the PFAS in the Raman spectrum.

Implementations of this aspect of the invention include one or more of the following. The system may further include equipment for comparing the CF₂ vibrational peak intensity of the PFAS to a calibration curve to obtain the PFAS concentration in the water sample. The CF₂ vibrational peak of the PFAS is detected at a wavelength of 1300 cm⁻¹ under excitation by a 785 nm laser light. The metallic nanoparticles comprise 40 nm silver nanoparticles (AgNPs). The metallic nanoparticles comprise a dispersion of AgNPs having a concentration of 0.02 mg/mL in aqueous buffer with sodium citrate as stabilizer. The thin film is deposited by drop-casting onto the substrate, or by spin-coating onto the substrate. The metallic nanoparticles are mixed into the water sample in a ratio of 2:3 water to metallic nanoparticles by volume. The metallic nanoparticles are mixed into the water sample using a mixer for 15 sec. The PFAS comprises a perfluorooctane sulfonic acid (PFOS) and the calibration curve for the PFOS is a logarithmic least squares fit equation of:

$$Y = 0.0044 ln ( x ) + 0.0561 .$$

The PFAS comprises a perfluorooctanoic acid (PFOA) and the calibration curve for the PFOA is a logarithmic least squares fit equation of:

$$Y = 0.0042 ln ( x ) + 0.0631 .$$

The substrate comprises aluminum. The CF₂ vibrational peak intensity of the PFAS is divided by the metallic nanoparticle particle peak intensity to correct for a heterogeneous distribution of the metallic nanoparticles in the thin film. The Raman spectrum acquisition time is scaled to 120 seconds exposure time.

### BRIEF DESCRIPTION OF THE DRAWINGS

Referring to the figures, wherein like numerals represent like parts throughout the several views:

FIG. 1 depicts graphs of Surface Enhanced Raman Spectra (SERS) and spontaneous Raman Spectra of PFOA (82, 88) and PFOS (84, 86) samples;

FIG. 2A depicts graphs of SERS Raman spectra of a PFOA serial dilution including concentrations in the range of 20 mg/L to 20 fg/l;

FIG. 2B depicts the PFOA molecule structure;

FIG. 3A depicts graphs of SERS Raman spectra of a PFOS serial dilution including concentrations in the range of 20 mg/L to 20 fg/l;

FIG. 3B depicts the PFOS molecule structure;

FIG. 4 depicts a plot of the least squares fit of the SERS Raman intensity versus the logarithm of the known concentration of PFOA in the calibration samples;

FIG. 5 depicts a plot of the least squares fit of the SERS Raman intensity versus the logarithm of the known concentration of PFOS in the calibration samples;

FIG. 6 is an overview diagram of the system for detecting Per- and polyfluoroalkyl substances (PFAS) in water sources, according to this invention;

FIG. 7 is a schematic diagram of the process for drop-casting of FIG. 6;

FIG. 8 is an overview diagram of the method for detecting Per- and polyfluoroalkyl substances (PFAS) in water sources, according to this invention; and

FIG. 9 depicts a bar graph of the comparison between the SERS and LC-MS results for drinking water in three different seasons.

### DETAILED DESCRIPTION OF THE INVENTION

The present invention describes a method and a system for detecting Per- and polyfluoroalkyl substances (PFAS) in water sources using silver nanoparticles for Surface-Enhanced Raman Spectroscopy (SERS).

Raman spectroscopy is based on Raman scattering, which is an inelastic light scattering process where the excitation photon couples to a phonon in the analyte and loses a discrete amount of energy. When the photon loses the quanta of energy, it changes wavelength. By measuring the wavelength shift of the Raman scattered photons, the phonon vibrational frequencies can be determined. Each molecule has a unique set of phonon vibrational modes, allowing for positive molecular identification. At low analyte concentrations, Raman signals require enhancement due to the rarity of spontaneous Raman scattering, with one photon undergoing Raman scattering in every ˜10⁸ excitation photons.

Surface-enhanced Raman spectroscopy (SERS) is a variant of Raman spectroscopy with high signal sensitivity that allows single molecule detection. SERS enhances Raman scattering by molecules adsorbed on rough metal surfaces or by metallic nanoparticles or nanostructures. The enhancement can be as high as 10¹⁰ to 10¹¹. Surface enhancement results from the localized surface plasmon resonance (LSPR) effect, which drastically increases Raman intensity. Using metallic nanoparticles with high degrees of curvature effectively enhances the local electric field experienced by the analyte molecule, leading to a higher probability of Raman scattering occurring. In the present invention, enhanced PFAS Raman signal sensitivity is achieved by adding metallic nanoparticles to the water sample. In one example, the metallic nanoparticles are silver nanoparticles (AgNPs).

The combination of surface electric field enhancement and Raman spectroscopy forms SERS, which allows for the highly sensitive detection of trace molecules. Additionally, SERS can be done quicker with less water than LC-MS. SERS can detect all chemical groups present during analysis, which better represents the PFAS concentration of a sample.

Table I compares the SERS method with current LC-MS methods. LC-MS is used as a comparison because it is used in published testing methods for the US Environmental Protection Agency (US EPA) and the American Society for Testing and Materials (ASTM).

TABLE I
SERS VS LC-MS COMPARISON

Testing Method

| Characteristic | LC-MS | SERS |
|---|---|---|
| Sensitivity | Detection limit | ~20 fg/L |
| | ~1 ng/L [13] | |
| Processing | >20 min | <30 seconds |
| time | runtime [12] | |
| Required | 250 mL [13] | A few drops |
| Water | | (<1 mL) |
| Can detect all | No | Yes |
| PFAS? | | |

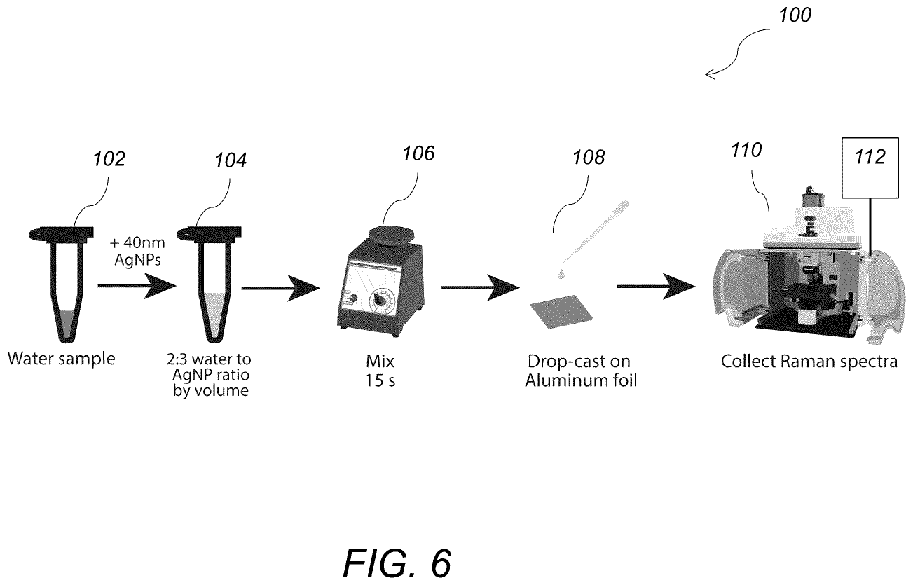

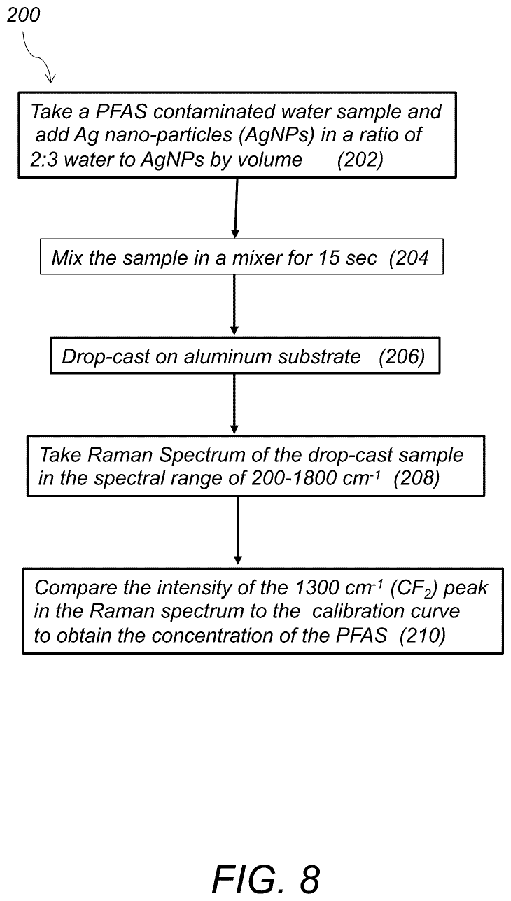

Referring to FIG. 6, a system 100 for detecting and measuring Per- and polyfluoroalkyl substances (PFAS) in water sources according to this invention includes sample holders 102, 104, a mixer 106, a drop-casting set-up 108, a Raman spectrometer 110, and a processor 112. Referring to FIG. 8, the method 200 for detecting and measuring Per- and polyfluoroalkyl substances (PFAS) in water sources with the system of FIG. 6 includes the following steps. First, a water sample is collected in a sample holder 102 and then silver nanoparticles AgNPs are added in a ratio of 2:3 water to AgNPs by volume (202). In one example, the AgNPs are 40 nm size particles. Next, the sample is placed in a test tube 104 and mixed in the mixer 106 for 15 sec (204). Next, a few drops of the mixed sample are dropped on an aluminum foil substrate to drop cast a test film of the sample in the drop-casting set up 108 (206). The drop-cast sample is analyzed with a Raman spectrometer 110 by taking Raman spectra in the spectral range of 200-1800 cm⁻¹ under an excitation with a 785 nm laser light (208). The spectral wavelength of a vibrational mode peak of PFAS is used to detect the presence of the PFAS compounds and the intensity of the peak is compared to a calibration curve to obtain the concentration of the PFAS. The comparison of the peak intensity to the calibration curve is performed by the processor 112.

### Materials and Methods

Long-chain PFAS are more bio-accumulative than short-chain PFAS. PFOA and PFOS are two of the most widely investigated and manufactured long-chain PFAS, so they were used to represent trace PFAS in the field. Perfluorooctanoic acid (PFOA), perfluorooctanesulfonic acid (PFOS), and 40 nm AgNP dispersion were purchased from Sigma-Aldrich. Each dispersion contains an AgNP concentration of 0.02 mg/mL in aqueous buffer with sodium citrate as stabilizer. AgNPs were mixed with water samples in a ratio of 2:3 and drop-cast on aluminum substrates. 40 nm AgNPs (kept at 5° C. before use) were selected with the aim of tuning SERS enhancement. Aluminum foil was chosen as a physical substrate to minimize Raman signal interference.

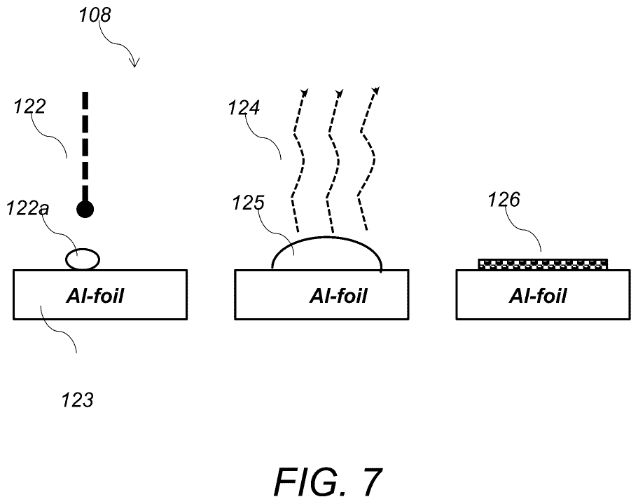

The drop-casting method is used for the formation of a small thin film or coating on a small surface area. Referring to FIG. 7, in the drop-casting method, a very small amount of solvent 122 is poured onto the substrate 123 as drops 122a and is allowed to dry without any spreading. When the first drop falls onto the substrate, the liquid first spreads on the surface from the drop location, due to the surface tension forces that drive the drop outward. As a few more drops are cast onto the substrate surface, the edges of the drops come in contact with each other, they get mixed together, and form a noncircular drop 125 with the concave contact line. The solvent is then evaporated 124, leaving behind a thin film 126 on the substrate 123.

### Instruments

Raman data of samples were collected on a Horiba XploRA Plus confocal Raman microscope. A 785 nm laser and 600 grooves/mm diffraction grating were used. The spectrometer was calibrated with a silicon wafer to the 520.7 wavenumber Si—Si peak before use, and an Olympus 50× long working distance microscope objective lens was used to pick out Raman spots from each sample. The analyzed spectral range was 200-1800 cm⁻¹.

Raman spectra were normalized for acquisition time and AgNP concentration. The acquisition time of each spectrum was scaled to 120 seconds exposure time to enable direct comparison between non-SERS enhanced Raman spectra and SERS enhanced Raman spectra. Additionally, Raman intensity was divided, when applicable, by the AgNP peak to correct for a heterogeneous distribution of AgNPs in the drop-cast sample.

### SERS for PFAS Detection

Prepared solutions of pure PFOA and PFOS at 1 g/L were compared with and without 40 nm AgNPs to investigate surface enhancement.

### Raman Spectra

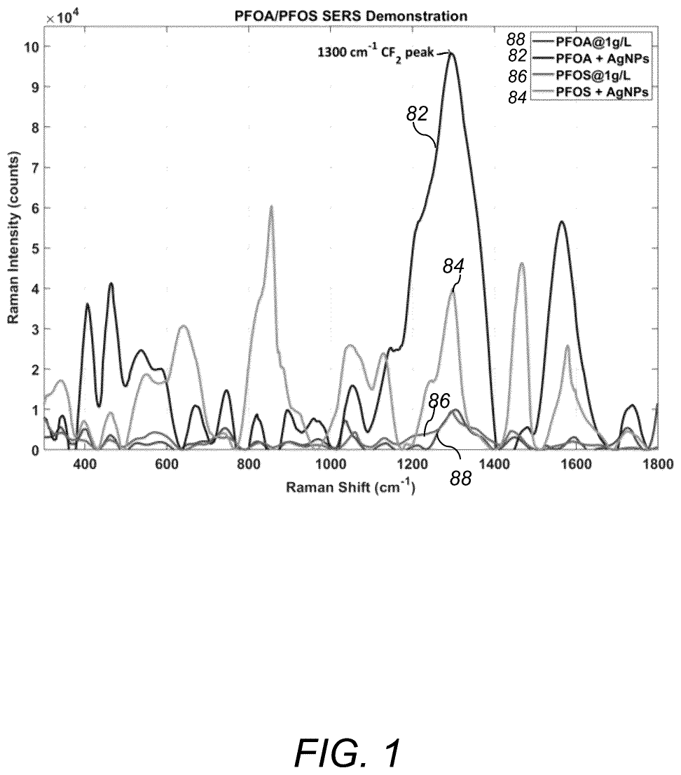

Raman spectra were taken of all samples PFOA 88, PFOA+AgNPs 82, PFOS 86 and PFOS+AgNPs 84 and showed high enhancement with the addition of 40 nm AgNPs, for the 1300 cm⁻¹ CF₂ Raman peak, as shown in FIG. 1. All spectra 88, 86, 84, 82 had signal-to-noise ratios greater than 9. Peaks of SERS and non-SERS samples align, indicating that 40 nm AgNPs enhance the signal of PFAS with no chemical interference. Thus, SERS has been demonstrated with a substantial enhancement for both PFAS.

FIG. 1 depicts a comparison of PFOA 82 and PFOS 84 SERS enhanced spectra and spontaneous Raman PFOA 88 and PFOS 86 spectra. At the 1300 cm⁻¹ peak, PFOA shows a 10×SERS enhancement and PFOS shows a 4×SERS enhancement. The 1300 cm⁻¹ peak is the CF₂ backbone in both the PFOA and PFOS molecules.

### Raman Feature Peak

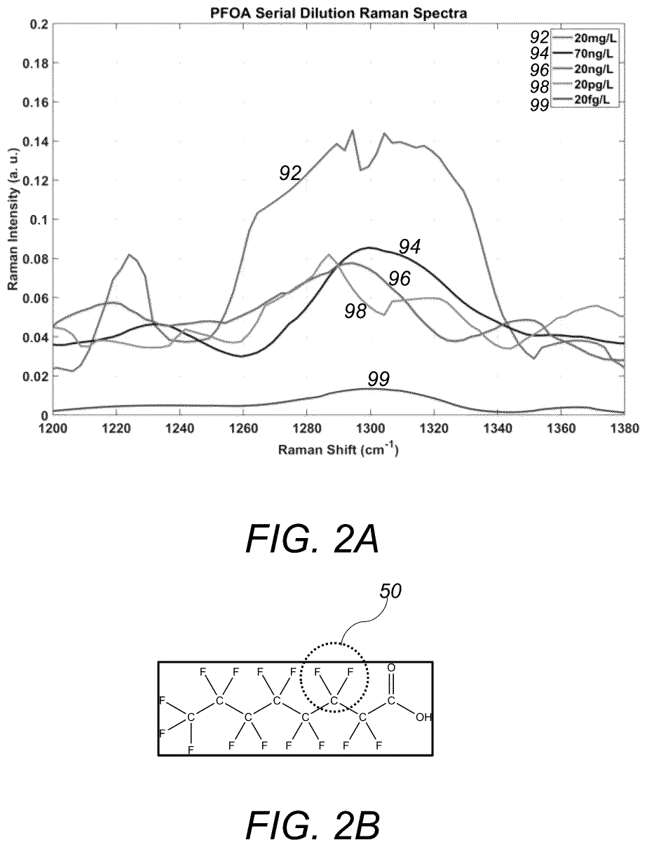

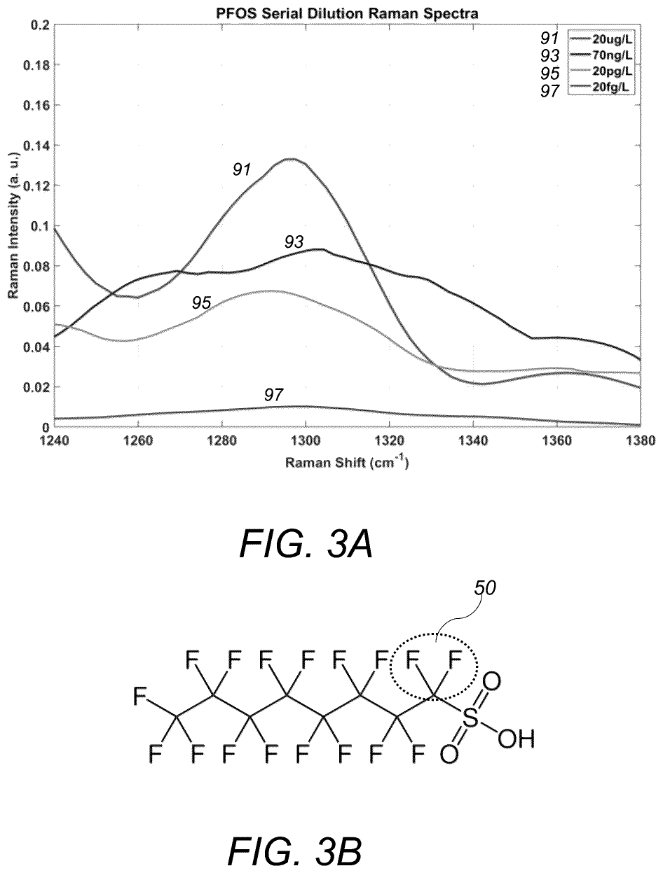

A Raman feature peak was identified at ˜1300 cm⁻¹ as the asymmetric stretching mode of the difluoromethylene (CF₂) group 50, which forms the backbone of PFAS, shown in FIG. 2B and FIG. 3B. Raman feature peaks are Raman bands characteristic of vibrational modes, which correspond to specific chemical structures.

### Creation of Concentration Calibration Curves

Using the feature peak identified at 1300 cm⁻¹, concentration calibration curves of PFOA and PFOS were generated to calculate the concentration of water samples.

Logarithmic serial dilutions for PFOA and PFOS, each containing seven solutions, were prepared ranging from 1 g/L to 20 fg/L (10⁻¹⁵ g/L), as shown in Table II below.

TABLE II
PFOA AND PFOS LOGARITHMIC SERIAL DILUTIONS

| | |
|---|---|
| Dilution | Concentration |

| # | PFOA | PFOS |
|---|---|---|
| 1 | 1 g/L | 1 g/L |
| 2 | 20 mg/L (ppm) | 20 mg/L (ppm) |
| 3 | 20 μg/L (ppb) | 20 μg/L (ppb) |
| 4 | 70 ng/L | 70 ng/L |
| 5 | 20 ng/L | 20 ng/L |
| 6 | 20 pg/L | 20 pg/L |
| 7 | 20 fg/L | 20 fg/L |

### Assessing Dilution Raman Spectra

Concentration calibration curves for both PFOA and PFOS were generated by taking Raman spectra of the known concentrations of the dilutions 1-7 of PFOA and PFOS of Table II, shown in FIG. 2A and FIG. 3A, respectively. Table III shows the Raman intensity of the 1300 cm⁻¹ Raman peak for all PFAS serial dilutions of Table II. All spectra have signal-to-noise ratios greater than 5, clearly indicating enhancement. The detection limit for PFOA and PFOS was found to be 20 fg/L.

To create the calibration curves, Raman intensities of PFOA dilutions 1 and 3 were excluded as outliers. In the PFOS serial dilution, intensities for dilutions 1, 2, and 5 were removed as outliers. This was done because the removed dilutions dramatically decreased the correlation of the PFAS calibration curves and did not follow the expected pattern of intensity decreasing with concentration.

TABLE III
1300 CM⁻¹ PEAK INTENSITIES OF DILUTION SPECTRA

Raman Intensity @ 1300 cm⁻¹

| Concentration | PFOA | PFOS |
|---|---|---|
| 1 g/L | 0.49 | 0.077 |
| 20 mg/L | 0.133 | 0.006 |
| 20 μg/L | 0.03 | 0.102 |
| 70 ng/L | 0.08 | 0.73 |
| 20 ng/L | 0.068 | 0.006 |
| 20 pg/L | 0.07 | 0.037 |
| 20 fg/L | 0.013 | 0.01 |

### Concentration Calibration Curves

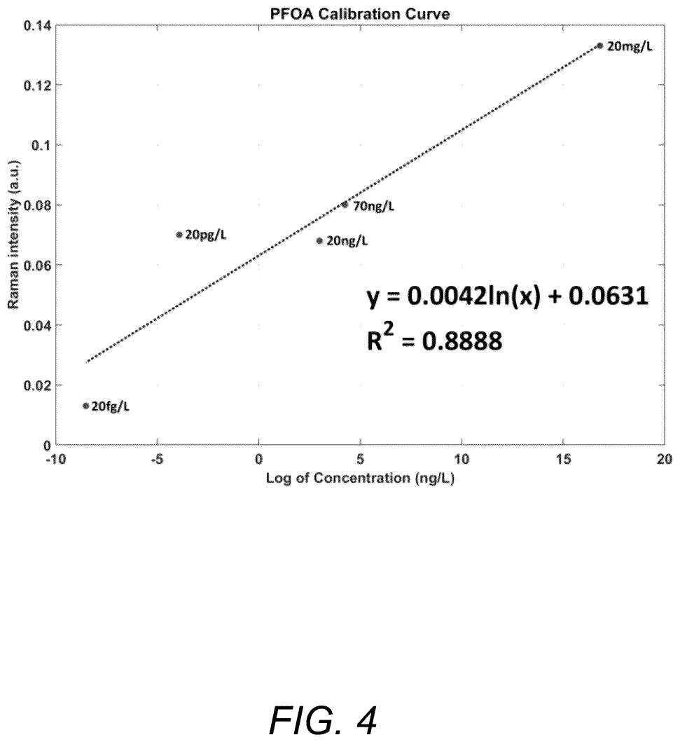

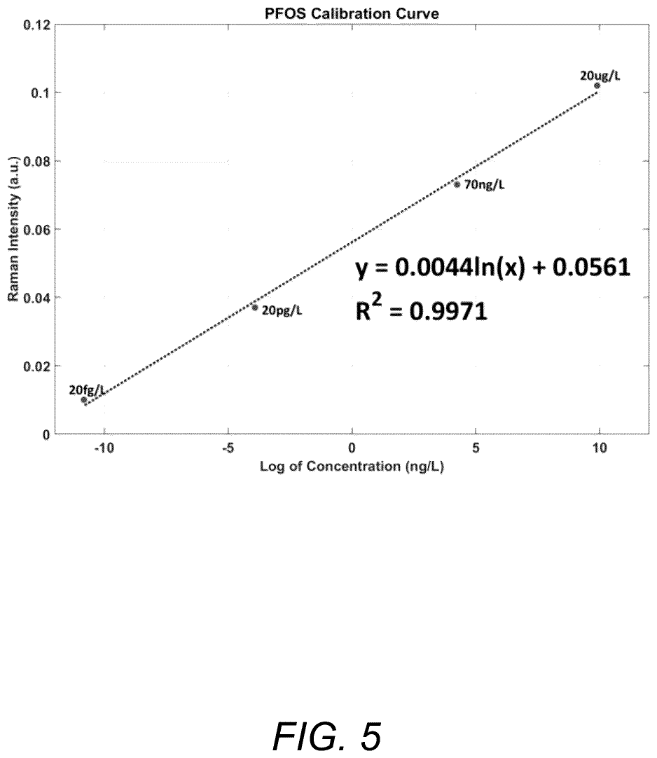

Raman intensity of the serial dilutions 1-7 was plotted with a fit line. Logarithmic least squares regression returned the highest correlation coefficient for both curves. Final concentration calibration curves are shown in FIG. 4 and FIG. 5 for PFOA and PFOS, respectively.

Referring to FIG. 4, a logarithmic least squares fit between the known concentration and the SERS Raman intensity of the PFOA calibration samples was performed, allowing the determination of PFOA concentration from the SERS signal intensity. The PFOA fit equation is shown below:

$$Y = 0.0042 ln ( x ) + 0.0631$$

where x is the concentration in ng/L and y is Raman signal intensity after scaling to 120 seconds with AgNP normalization. The R² value for the PFOA concentration calibration curve is 0.8888, indicating a strong correlation between concentration and Raman intensity. The PFOA curve was able to resolve and detect concentrations at 20 fg/L with a signal-to-noise ratio of 5.

Referring to FIG. 5, a logarithmic least squares fit between the known concentration and the SERS Raman intensity of the PFOS calibration samples was performed, allowing the determination of PFOS concentration from the SERS signal intensity. The PFOS fit equation is shown below:

$$Y = 0.0044 ln ( x ) + 0.0561$$

where x is the concentration in ng/L and y is Raman signal intensity after scaling to 120 seconds with AgNP normalization. The R² value for the PFOS concentration calibration curve is 0.9971, also indicating a strong correlation between concentration and Raman intensity. The PFOS curve was able to resolve and detect concentrations at 20 fg/L with a signal-to-noise ratio of 20.

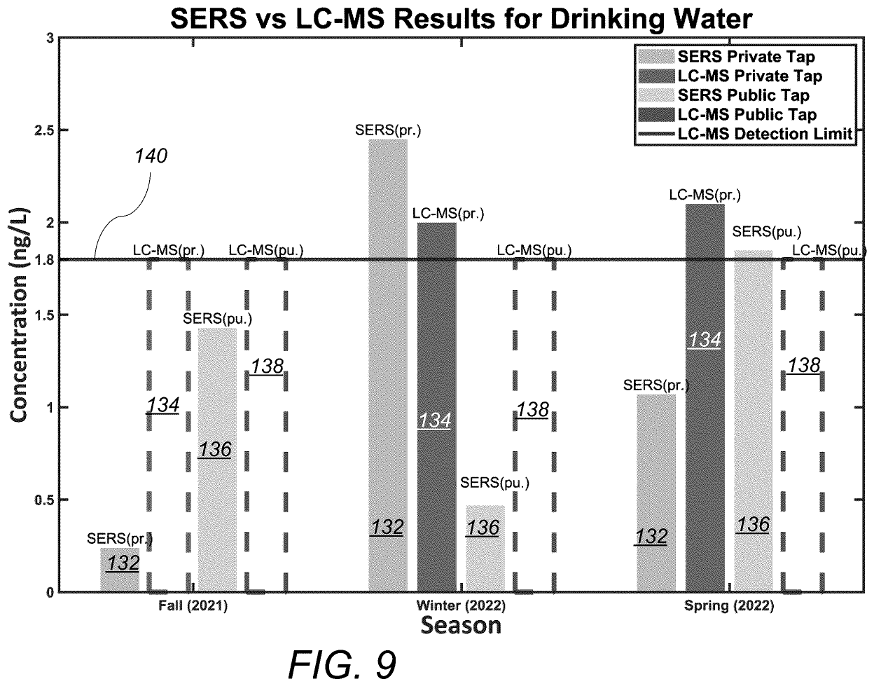

Drinking water samples from the Town of Wellesley were analyzed with the SERS method of FIG. 8 using drop-cast 40 nm AgNP to measure trace PFAS. The water samples were collected from a private source (private residence in Wellesley Hills) and from a public source (Wellesley High School). The SERS results were plotted in the bar graph of FIG. 9 for samples collected during the fall of 2021, the winter of 2022 and the spring of 2022. The water samples were also analyzed with the LC-MS method and the results were also plotted in the graph of FIG. 9. The LC-MS detection limit of 1.8 ng/L is also plotted as a solid line 140 in the graph of FIG. 9. In the fall of 2021, the LC-MS method detected no PFAS both in the private tap water sample 134 and the public tap water sample 138, whereas the SERS method detected 0.25 ng/L of PFAS in the private tap water sample 132 and 1.45 ng/L of PFAS in the public tap water sample 136. In the winter of 2022, the LC-MS method detected 2 ng/L of PFAS in the private tap water sample 134 and no PFAS in the public tap water sample 138, whereas the SERS method detected 2.45 ng/L in the private tap water sample 132 and 0.5 ng/L in the public tap water sample 136. In the spring of 2022, the LC-MS method detected 2.1 ng/L of PFAS in the private tap water sample 134 and no PFAS in the public tap water sample 138, whereas the SERS method detected 1.1 ng/L in the private tap water sample 132 and 1.85 ng/L in the public tap water sample 136.

Based on the above mentioned results it is shown that the SERS method for detecting PFAS in water source provides the following advantages, among others.
1. High sensitivity—40 nm AgNPs provide substantial enhancement for PFASs. The method can measure concentrations at 20 fg/L, six orders of magnitude below the prior art methods, which detect at the 1.8 ng/L level.
2. Ease of use—SERS sample preparation requires mixing less than one mL of sample water because drop-casting utilizes individual drops of water. The volume of water samples used in the prior art methods (LC-MS, GC-MS) commonly exceeds 250 mL.
3. Speed—SERS can return results in less than thirty seconds, while the prior art methods have a runtime of twenty minutes or more.

Other embodiments of the invention include one or more of the following. Silver nanoparticles in the range of 10 nm-100 nm may be used. Nanoparticles of other metals, such as gold or platinum may be used. The substrate may be any roughened metal surface such as gold, silver, copper or platinum, among others. In other embodiments, the substrate includes a metallic nanostructure array (such as copper or gold or silver) fabricated directly on a solid substrate. The thin films may be deposited by spin coating. The Raman spectrometer may be a lab-size equipment or a portable Raman spectrometer. In other embodiments, the laser beam of the Raman spectrometer may be in the visible range, such as lases at 532 nm wavelength.

Several embodiments of the present invention have been described. Nevertheless, it will be understood that various modifications may be made without departing from the spirit and scope of the invention. Accordingly, other embodiments are within the scope of the following claims.

What is claimed is:

1. A method for detecting Per- and polyfluoroalkyl substances (PFAS) in water sources comprising:
taking a water sample from the water source and mixing metallic nanoparticles into the water sample;
depositing a thin film of the mixed water with the metallic nanoparticles on a substrate;
performing Raman spectroscopy on the prepared thin film of the mixed water with the metallic nanoparticles to obtain a Raman spectrum and detect presence of a difluoromethylene (CF₂) vibrational peak of the PFAS in the Raman spectrum.

2. The method of claim 1, further comprising comparing the CF₂ vibrational peak intensity of the PFAS to a calibration curve to obtain the PFAS concentration in the water sample.

3. The method of claim 1, wherein the CF₂ vibrational peak of the PFAS is detected at a wavelength of 1300 cm⁻¹ under excitation by a 785 nm laser light.

4. The method of claim 1, wherein the metallic nanoparticles comprise 40 nm silver nanoparticles (AgNPs).

5. The method of claim 1, wherein the metallic nanoparticles comprise a dispersion of AgNPs having a concentration of 0.02 mg/mL in aqueous buffer with sodium citrate as stabilizer.

6. The method of claim 1, wherein the thin film is prepared by drop-casting onto the substrate.

7. The method of claim 1, wherein the thin film is prepared by spin-coating onto the substrate.

8. The method of claim 1, wherein the metallic nanoparticles are mixed into the water sample in a ratio of 2:3 water to metallic nanoparticles by volume.

9. The method of claim 1, wherein the metallic nanoparticles are mixed into the water sample using a mixer for 15 sec.

10. The method of claim 1, wherein the PFAS comprises a perfluorooctane sulfonic acid (PFOS) and the calibration curve for the PFOS is a logarithmic least squares fit equation of:
$$Y = 0.0044 ln ( x ) + 0.0561 .$$

11. The method of claim 1, wherein the PFAS comprises a perfluorooctanoic acid (PFOA) and the calibration curve for the PFOA is a logarithmic least squares fit equation of:
$$Y = 0.0042 ln ( x ) + 0.0631 .$$

12. The method of claim 1, wherein the substrate comprises aluminum.

13. The method of claim 1, wherein the CF₂ vibrational peak intensity of the PFAS is divided by the metallic nanoparticle particle peak intensity to correct for a heterogeneous distribution of the metallic nanoparticles in the thin film.

14. The method of claim 1, the Raman spectrum acquisition time is scaled to 120 seconds exposure time.

15. A system for detecting Per- and polyfluoroalkyl substances (PFAS) in water sources comprising:
equipment for mixing metallic nanoparticles into a water sample taken from the water source;
equipment for depositing a thin film of the mixed water with the metallic nanoparticles on a substrate;
equipment for performing Raman spectroscopy on the prepared thin film of the mixed water with the metallic nanoparticles to obtain a Raman spectrum and detect presence of a difluoromethylene (CF₂) vibrational peak of the PFAS in the Raman spectrum.

16. The system of claim 15, further comprising equipment for comparing the CF₂ vibrational peak intensity of the PFAS to a calibration curve to obtain the PFAS concentration in the water sample.

17. The system of claim 15, wherein the CF₂ vibrational peak of the PFAS is detected at a wavelength of 1300 cm⁻¹ under excitation by a 785 nm laser light.

18. The system of claim 15, wherein the metallic nanoparticles comprise 40 nm silver nanoparticles (AgNPs).

19. The system of claim 15, wherein the metallic nanoparticles comprise a dispersion of AgNPs having a concentration of 0.02 mg/mL in aqueous buffer with sodium citrate as stabilizer.

20. The system of claim 15, wherein the thin film is deposited by drop-casting onto the substrate.

21. The system of claim 15, wherein the thin film is deposited by spin-coating onto the substrate.

22. The system of claim 15, wherein the metallic nanoparticles are mixed into the water sample in a ratio of 2:3 water to metallic nanoparticles by volume.

23. The system of claim 15, wherein the metallic nanoparticles are mixed into the water sample using a mixer for 15 sec.

24. The system of claim 15, wherein the PFAS comprises a perfluorooctane sulfonic acid (PFOS) and the calibration curve for the PFOS is a logarithmic least squares fit equation of:
Y=0.0044 ln(x)+0.0561.

25. The system of claim 15, wherein the PFAS comprises a perfluorooctanoic acid (PFOA) and the calibration curve for the PFOA is a logarithmic least squares fit equation of:
$$Y = 0.0042 ln ( x ) + 0.0631 .$$

26. The system of claim 15, wherein the substrate comprises aluminum.

27. The system of claim 15, wherein the CF₂ vibrational peak intensity of the PFAS is divided by the metallic nanoparticle particle peak intensity to correct for a heterogeneous distribution of the metallic nanoparticles in the thin film.

28. The system of claim 15, the Raman spectrum acquisition time is scaled to 120 seconds exposure time.
